(19) United States
(12) Patent Application Publication
(10) Pub. No.: US 2015/0159770 A1
(43) Pub. Date: Jun. 11, 2015

(54) COMPACT METERING DEVICE

(71) Applicants: Antoine Foucaut, Montarlot les Rioz (FR); Cédric Mellere, Soulce Cernay (FR)

(72) Inventors: Antoine Foucaut, Montarlot les Rioz (FR); Cédric Mellere, Soulce Cernay (FR)

(73) Assignee: SONCEBOZ AUTOMOTIVE SA, Sonceboz (CH)

(21) Appl. No.: 14/237,272

(22) PCT Filed: Aug. 7, 2012
(86) PCT No.: PCT/FR2012/051855

§ 371 Date: Jul. 2, 2014

(30) Foreign Application Priority Data
Aug. 8, 2011 (FR) 11/57230

(51) Int. Cl. F16K 31/10; F16K 31/06; F16K 37/00; F16K 1/00

(52) U.S. Cl. CPC F16K 31/10; F16K 1/00; F16K 31/0655; F16K 37/0033

(57) ABSTRACT

A metering device including: a valve body equipped with a valve shutter designed to move between a closed position and an open position, a transmission shaft having a first end connected to the valve shutter and a second end connected to a cam element, a rotary electric actuator including a stator assembly and a rotor assembly able to rotate about an axis of rotation, the rotor assembly including a magnetic support frame bearing a rotor magnet. The rotor assembly further includes a follower fixed to the magnetic support frame and eccentric with respect to the axis of rotation and positioned with the ability to move in the cam element in order to convert the rotary movement of the rotor assembly into a movement of the transmission shaft.

### CROSS-REFERENCE TO RELATED APPLICATIONS

This application is a National Phase Entry of International Application No. PCT/FR2012/051855, filed on Aug. 7, 2012, which claims priority to French Patent Application Serial No. 1157230, filed on Aug. 8, 2011, both of which are incorporated by reference herein.

### BACKGROUND

The present invention relates to a metering device comprising a valve body equipped with a valve shutter designed to move between a closed position and an open position, a transmission shaft having a first end connected to the valve shutter and a second end connected to a cam element and a rotary electric actuator comprising a stator assembly and a rotor assembly able to rotate about an axis of rotation, the rotor assembly comprising a magnetic support frame bearing a rotor magnet. All heat engines for automobiles today are equipped with fluid metering systems of different kinds to optimize mechanical efficiency or reduce the pollutant emissions. Such metering valves are usually electrically controlled from direct current motors or actuators of the torque motor type.

Metering valves based on the use of a direct current motor associated with a reducing gear provide poor reliability due to the wear of the collector ring brushes, but also to the wear of the gears used to downshift the effective torque. However, these solutions have a relatively low cost since they use a small size motor. They represent a major part of the EGR (acronym for “Exhaust Gas Recirculation”) valves market. Their major drawbacks are, on the one hand, the lack of reliability and, on the other hand, the overall dimensions penalized by the integration of the kinematic chain, resulting in a little compact valve difficult to fit on the engine.

The Patents EP1091112A2 and EP1526271A1 are more particular known, which provide for a gas recirculation valve comprising a direct current motor associated with a reducing gear and a cam movement conversion system. These solutions have the advantage, as regards the maximum force exerted on the valve, because of the high gear reduction of the reducing gear. However, the overall size of the valve is important and complicates the integration on the engine environment. In addition, the brush motor used and the reducing gears show inevitable wear which reduces the valve performances over time, and does not enable to reach a very long service life. These solutions are interesting for their low cost but fail to satisfactorily meet the reliability and compactness stresses. Besides, engines environments are increasingly confined and the temperature and vibration conditions are always stricter.

The metering valves based on the use of a torque motor prove extremely reliable due to the absence of a reducing gear and to the simple construction of this type of engine. The compactness of the solution is slightly better than the solutions with direct current motors because of the direct driving of the cam without a reducing gear. However, the cost of these solutions using rare earth magnets is slightly higher.

The patent DE102007036286A1 discloses, in FIGS. 1 to 3, a solution wherein the engine torque comprises a control shaft that drives a cam which cooperates with a follower integral with the valve element able to move in translation. This type of construction also results in a large overall size of the valve because the electric actuator is offset from the axis of symmetry of the metering valve. This constraint applied to the positioning of the actuator relative to the valve shaft restricts the compactness of the entire valve. Besides, this solution results in a complex and expensive assembling sequence for connecting the cam with the actuator shaft.

As a matter of fact, the rotor magnet retains its magnetisation only if it does not exceed a maximum temperature close to 220 degrees. This is the reason why the welding linking the cam to the rotor shaft must be strictly local, using a low intensity source of the laser beam type. This technology is reliable, provided the adjustment in diameter between the two parts is excellent, which imparts tight machining tolerances and thus significant associated costs. Moreover the implementation of the follower on the valve shaft is provided by means of a pin driven into a magnetic support frame, so as to balance the load of the follower on the valve. This assembly is difficult to execute and generates a complex automatic mounting procedure.

Besides, the rotary position sensor integrated in the motor torque is used to control the position of the valve. This solution is partially satisfactory since it does not enable to know the exact position of the valve but only the angular position of the cam. In this case, the angular clearance of the follower cam conversion distorts the reading accuracy of the position of the valve and does not enable an optimal control of the metering performed.

The German patent DE 10 2009 003 882 A1 is known, which describes a concept enabling to position a magnetic field source on the stem of the valve and to insert a magneto-sensitive element into the lower part of the engine torque in order to directly detect the position of the valve. This concept may seem attractive as regards its principle, but it is not feasible on an industrial scale because, on the one hand, the valve shaft which supports the field source must be made of stainless steel to withstand the temperature and the corrosive atmosphere in this environment, as this grade of steel is non-magnetic and very detrimental to the level of magnetic flux density created by the field source, and on the other hand, because the magneto-sensitive element is electrically connected by a flexible cable overmoulded in the stator without any associated electronic filtering component and without any positioning element ensuring the correct operation of the sensor. Eventually, the configuration of the valve still has the disadvantage of having a rather long electric tubular actuator, fitted perpendicularly to the valve shaft, which makes the valve asymmetric and penalizes the integration thereof into the vehicle engine.

In addition to the previous exemplary metering valves using a valve able to move in translation, many metering valves using a valve shutter able to move in rotation and closing a cylindrical conduit can also be found in the prior art. The German patent EP1526272B1 which describes a gas recirculation valve based on the combination of an electric actuator, a rotary cam system driving a rotary valve shutter for metering gas should more particularly be noted, too. This solution discloses a unique kinematics installed between the control element of the electric actuator and the metering system, in order to provide the valve shutter with a maximum torque at the beginning of the actuation stroke. This solution is of no particular interest as regards the problem of the overall size of the metering system mentioned above.

The European patent EP1526272 is also known, which describes an exhaust gas recirculation valve, comprising a rotary drive, a valve element movable in rotation between an open position and a closed position, and a cam element transmitting the rotary movement to the valve element. This solution is not satisfactory because it implements a follower which is borne by a lever coupled to the motor shaft. This causes clearance and overhang which does not ensure repeatability of the position when the wear causes dimensional defects.

The patent WO89/01105 is also known, which discloses an electrically-controlled EGR valve comprising a valve stem positioned eccentric relative to an axis of rotation and substantially axially movable relative to a valve seat. A poppet valve is borne by the valve stem to close the valve seat. A first shaft is positioned eccentric relative to the axis of rotation and connected to one end of the valve stem. An electrically-controlled actuator, such as a torque motor rotates the first shaft around the axis to move the valve stem.

The patent EP1319879 is also known, which discloses a direct action electric reducing valve having a motor-actuated electric reciprocating stem. During the direct action of the electrically-controlled valve, as the stem vertical reciprocating movement, a first passage and a second passage are switched. A cam mechanism is formed to convert the alternating rotary movement of an eccentric cam which performs a rotating reciprocating movement driven by an electric motor 40 into a vertical reciprocating movement.

The patent DE10336976 is also known, which describes a valve comprising a two-part housing. The first part of the housing has a channel and the valve seat. The second housing part comprises a control unit and a valve stem.

### SUMMARY

The rotor assembly includes a follower. The rotor assembly is defined by:
1. The magnetic support frame
2. Bearing a rotor magnet.
   The follower is an integral part of the magnetic support frame bearing the rotor magnet.

The advantage of this embodiment is to avoid the problems associated with driving a lever coupled to the motor shaft. These solutions of the prior art demonstrate various disadvantages: loss of position accuracy and repeatability due to the clearance that may occur at the coupling of the lever on the motor shaft, assembling and adjustment problems, increasing distance between the ball stop and the stator bearing, generation of radial stresses by the follower/cam kinematics.

The invention makes it possible to reduce the overhang and the induced stresses. It therefore also results in greater strength. It is therefore advantageous to provide a metering valve with a small footprint although reliable and lasting, for as low as possible a manufacturing cost.

To solve one or more of the above-mentioned drawbacks, a metering device comprises:
a valve body provided with a shutter valve designed to move between a closed position and an open position,
a transmission shaft having a first end connected to the shutter valve second end connected to a cam element,
an electric actuator able to rotate, comprising a stator assembly and a rotor assembly able to rotate about an axis of rotation, the rotor assembly comprising:
a magnetic support frame bearing, and
a rotor magnet.
   In addition, the rotor assembly includes a follower fixed directly on the magnetic support frame, eccentric with respect to the axis of rotation and positioned with the ability to move in the cam element in order to convert the rotary movement of the rotor assembly into a movement of the transmission shaft.

The solution which is the object of the present invention enables to simplify the architecture of the valve and to increase the accuracy of the angular positioning between the follower and the motor magnet, insofar as the motor magnet is directly linked to the magnetic support frame, and more particularly since the motor magnet can be magnetized on the magnetic support frame already comprising the follower (i.e. the magnetic patterns of the motor magnet are directly indexed with respect to the follower during the magnetization process and are no longer dependent on the “axis/added lever/assembling operation” kinematic chain. This results in a much greater positioning accuracy.

This invention also makes it possible to reduce the number of parts and thus the cost by avoiding some additional parts. A sealed cowling provides for a simple and efficient protection of the follower/cam kinematics. More particularly, the direct fixing of the follower on the magnetic support frame considerably reduces the distance between the ball stop 1 and the stator bearing and reduces the radial stresses generated by the follower/cam kinematics. The overhang is minimal and so are the induced stresses. This results in a greater strength. Advantageously, the metering device is based on the combination of an electric actuator and a metering valve and provides for a different integration of the movement conversion kinematics while keeping a simple mass production.

Particular characteristics or embodiments, to be used alone or in combination, are as follows:
a permanent magnet is fixed onto the cam element, with the permanent magnet cooperating with a magneto-sensitive element fixed to the stator assembly to form a position sensor, thus providing a simple solution of position sensor enabling to control the actual position of the valve;
the cam element is made of a ferromagnetic material;
the position sensor operates in linear mode;
the magneto-sensitive element is fixed to the stator assembly by means of a rigid conductive structure;
it further comprises a return spring, one end of which is fixed to the stator assembly and a second end of which is fixed to the rotor assembly at an eccentric point of the axis of rotation of the rotor assembly;
the follower being able to rotate about a nose fixed to the magnetic support frame, the magnetic support frame, the axis of the rotor assembly and the nose are formed in a single metal piece;
the shutter valve and the transmission shaft move in a translational movement, the cam element may then comprise a raceway intersecting the transmission shaft and/or the raceway may be perpendicular to the transmission shaft; or
the shutter valve and the transmission shaft move in a rotary movement about the longitudinal axis of the transmission shaft and the cam element may then comprise a raceway making it possible to modify the angular stroke of the rotor assembly.

In a second aspect of the invention, a method for assembling a metering device as described above comprises:
the transmission shaft and the cam element are fixed together and then the whole is assembled in the valve body,
the follower is fixed to the magnetic support frame, and then
the follower is positioned opposite the cam element, and
the electric actuator is pressed and fixed against the valve body.
   In a particular embodiment of this method, the rotor magnet is magnetized after fixing thereof to the magnetic support frame.

Thus, the mounting direction of the torque motor is advantageously reversed with respect to the metering valve in order to operate not the central axis of the rotor of the actuator, but directly the movement of the magnetic support frame as the output element of the actuator, the magnetic support frame carries a follower cooperating with the cam element connected to the valve to be controlled. This is particularly interesting as regards compactness since the height of the electric actuator is substantially reduced and the compactness of the metering system is improved. In addition, a complete sealing of the valve is ensured since the stator of the motor torque is totally overmoulded on the rear part, and no cover is added, as was the case in the known solutions. As a matter of fact, plastic covers may have defects in their connections with the stator and entail the introduction of moisture into the front part of the actuator. If necessary, a seal may be installed.

### BRIEF DESCRIPTION OF THE DRAWINGS

The invention will be better understood upon reading the following description given by way of example, and with reference to the appended drawings wherein:

FIGS. 1 to 3 are schematic views of a metering device according to the prior art;

FIG. 4 is a front perspective view of a first embodiment;

FIG. 5 is a top perspective view of the first embodiment;

FIG. 6 is a front view of a first mode of operation of the first embodiment with the associated stress graph;

FIG. 7 is a front view of a second mode of operation of the first embodiment with the associated stress graph;

FIG. 8 is a side view of the first embodiment;

FIG. 9 is a front perspective view of a second embodiment;

FIG. 10 is a front perspective view of a third embodiment; and

FIG. 11 is a front sectional view of the third embodiment.

### DETAILED DESCRIPTION

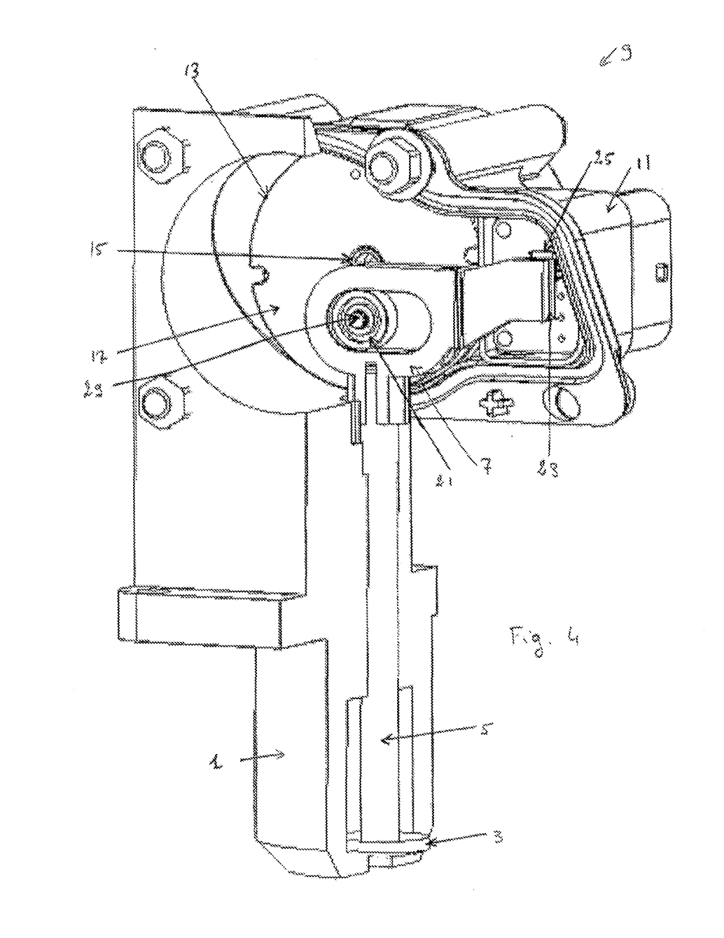

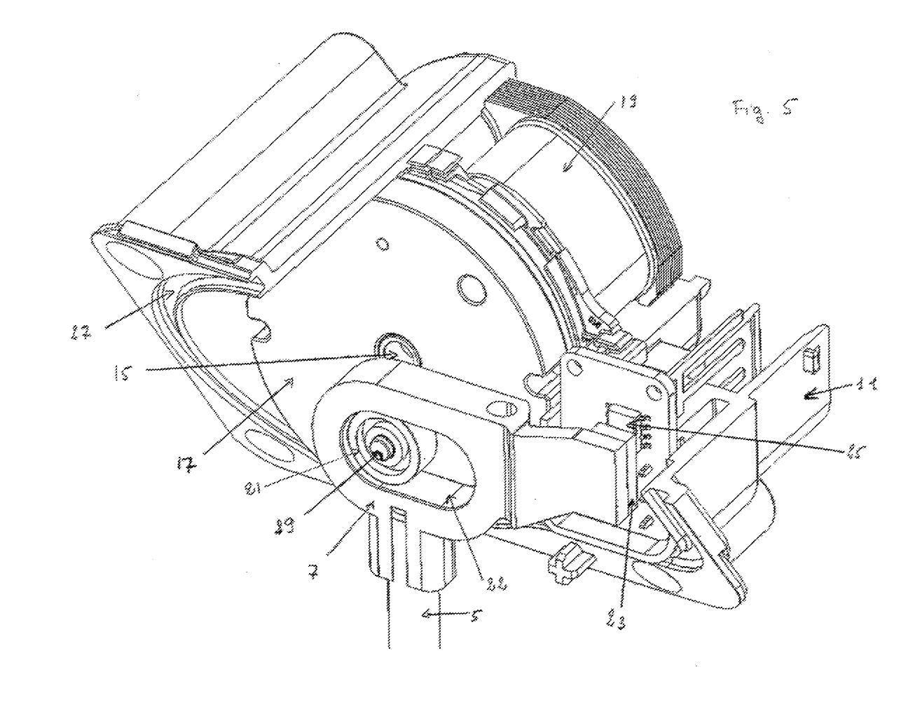

Throughout the specification and drawings, the same reference number refers to functionally identical or similar items. With reference to FIGS. 4 and 5, a first embodiment is shown wherein the movement of the valve is linear. The metering device comprises a valve body 1 provided with a shutter valve 3 designed to move between a closed position and an open position (the shutter valve is in closed position in the Figure). A transmission shaft 5 has a first end connected to the shutter valve 3 and a second end connected to a cam element 7.

A rotary electric actuator 9 comprises a stator assembly 11 and a rotor assembly 13 able to rotate about an axis of rotation 15. The rotor assembly 13 includes a magnetic support frame 17 bearing a rotor magnet 19. It also comprises a follower 21 fixed to the magnetic support frame 17. The follower 21 is eccentric with respect to the axis of rotation 15 and positioned with the ability to move in the cam element 7. In particular, the follower 21 moves in a raceway 22 of the cam element 7.

The cam element 7 is made of a ferromagnetic material and bears a magnetic field emitter 23 which is detected by a magneto-sensitive element 25 secured to the stator 11 of the electrical actuator 9, the magnetic field transmitter 23 and the magneto-sensitive element 25 forming a position sensor. The kinematic chain, which transmits the movement from the magnet motor 19 to the shutter valve 3, is reduced to the maximum and enables to reduce the height of the actuator and to obtain a compact and easy to integrate metering valve. This solution thus makes it possible to reduce the number of components and thus the manufacturing costs of the metering device. The transmission torque created at the rotor magnet 19 is transmitted to the follower 21 without passing through the guiding pin 15, and thus it is not exposed to the torsion of the pin 15, which, with the solutions of the prior art, induced a loss of accuracy in the kinematic chain, and thus as regards the positioning of the shutter valve 3.

The magnetic field emitter 23 is fixed to the cam element 7, which is made of a ferromagnetic material. This enables to achieve a high enough level of magnetic flux density at the magneto-sensitive element 25 to ensure insensitivity of the position sensor to external magnetic disturbances. Moreover, the magneto-sensitive element 25 is fixed to the stator assembly 11 by a rigid conductive structure. The position sensor programmed to operate in linear mode makes it possible to precisely control the position of the shutter valve 3 throughout the stroke thereof and thus a precise control of the flow of the metering device. The plastic overmoulded stator 11 is closed on the rear part and has a groove 27 receiving a seal at the front, so that the connection between the electric actuator 9 and the body 1 of the metering valve is perfectly tight.

The fixing of the follower 21 on the magnetic support frame 17 is much simpler than the known solutions, since it is based on a conventional fitting on a rigid shaft, or nose 29. The magnetic support frame 17, axis of rotation 15 and nose 29 assembly may also be formed in the same piece of metal. The assembly composed of the transmission shaft 5 and the cam element 7 can be assembled independently and easily and then installed in the valve body 1 before welding the shutter valve 3 while adjusting its position.

The angular setting of the electric stroke and of the mechanical stroke of the actuator is facilitated by an accurate positioning of the follower 21 on the magnetic support frame 17 but also by fixing the rotor magnet 19 on the magnetic support frame 17. Moreover it should be noted that it is possible to magnetize the magnet 19 after mounting the latter on the magnetic support frame 17, in order to improve the angular orientation of the multipolar transitions with respect to the follower 21 and optimize the accuracy of the metering device.

Eventually, this embodiment enables a simple assembly of the electric actuator 9 on the metering device. As a matter of fact, it is sufficient to position the follower 21 opposite the raceway 22 of the cam 7, and then to press and fix the actuator 9 against the valve body 1. It can be noted that, depending on whether the follower 21 is located in the upper quadrant or the lower quadrant at the start of the angular stroke of the rotor, and depending on the shape of the cam 7, a force profile can be created on the valve shaft 5 which is either increasing or decreasing during the stroke, depending on the application requirements of the metering device.

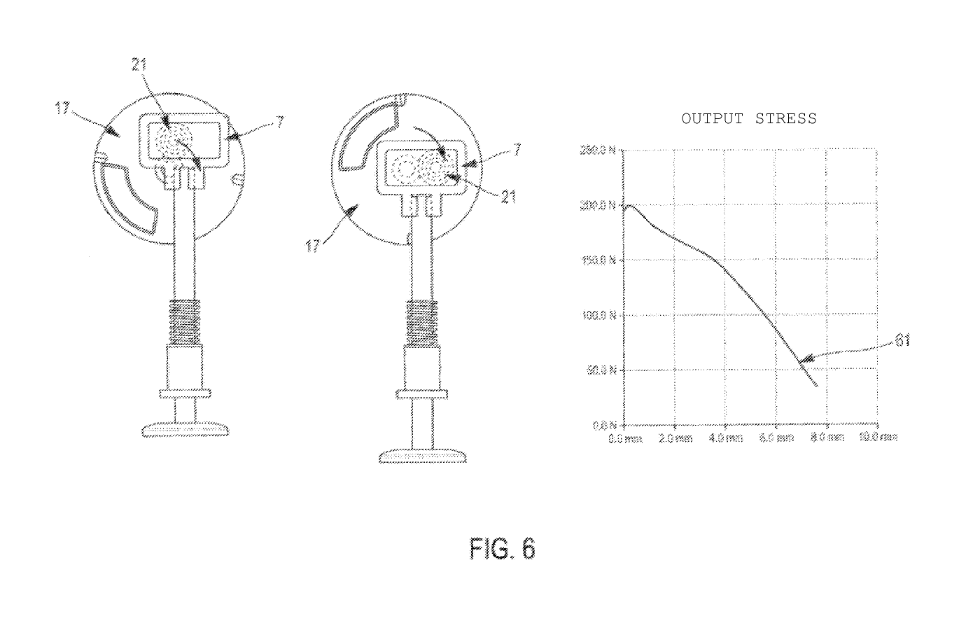

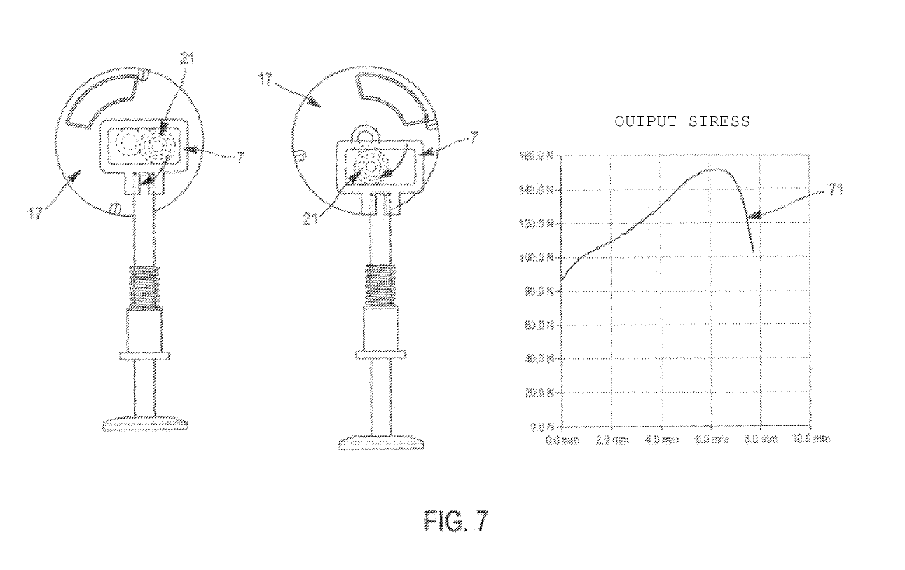

FIG. 6 shows the magnetic support frame 17 equipped with the follower 21 which cooperates with the cam element 7. The raceway 22 is straight and the axis of rotation intersects the transmission shaft, and is more particularly perpendicular thereto. The follower 21 and the cam element 7 operate in the upper right quadrant in order to obtain a maximum strength at the start of the stroke, as shown in the stress graph 61, which force is transmitted to the transmission shaft 5 fixed to the shutter valve 3. FIG. 7 shows the magnetic support frame 17 equipped with a follower 21 which cooperates with the cam element 7 as in the previous figure, but which works in the lower right quadrant in order to obtain a maximum force at the stroke limit, as shown in the stress graph 71, which force is transmitted to the transmission shaft 5 fixed to the shutter valve 3.

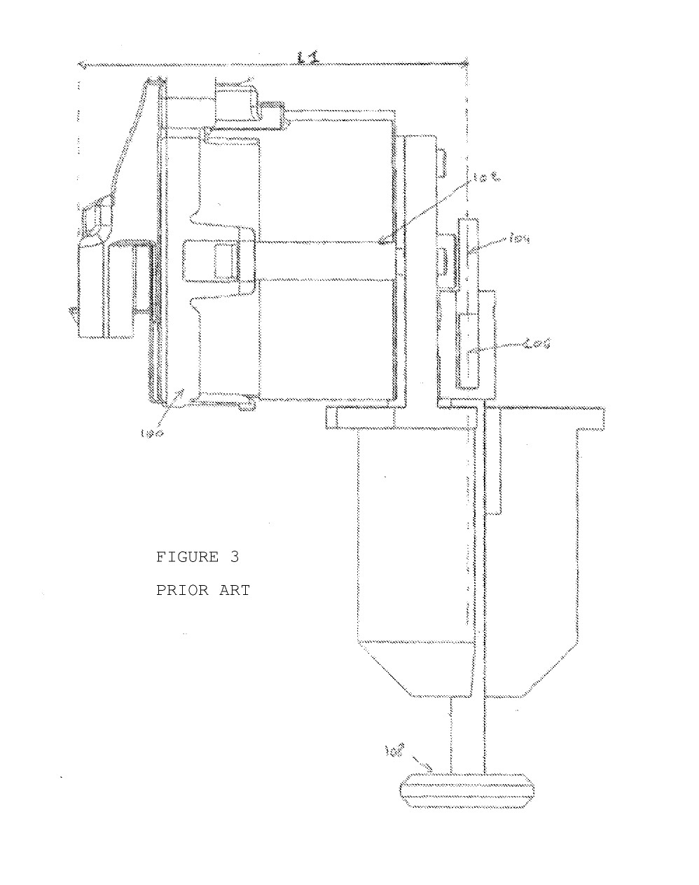

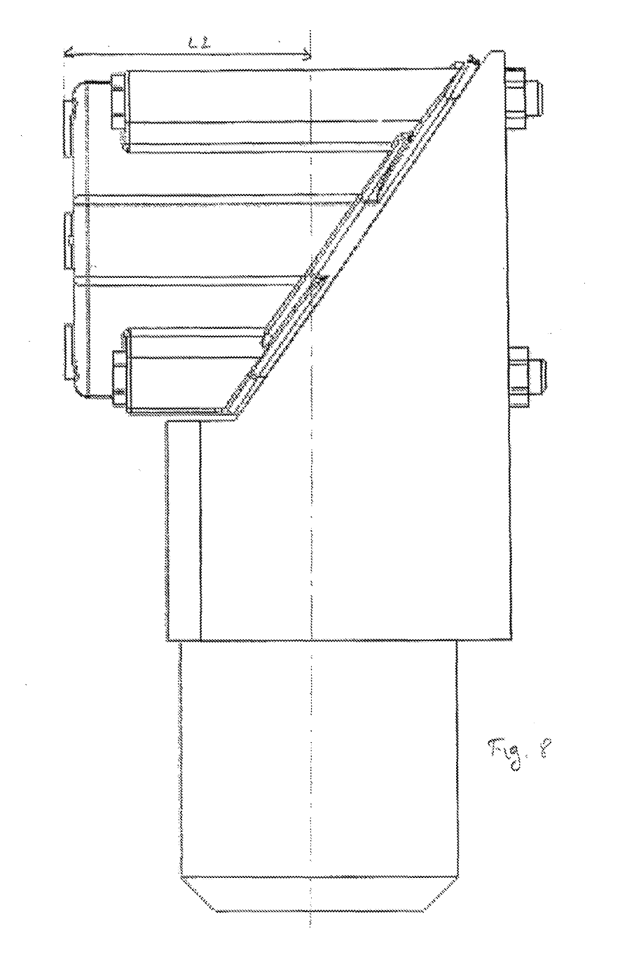

FIG. 8 shows a side view of the device described and enables a comparison of the radial footprint with the metering device according to the prior art as shown in FIG. 3. The dimension referred to as “L2” is the radial footprint measured between the rear face of the motor and the axis of symmetry of the metering valve in the case of the embodiment described above. This dimension is reduced by 40% as compared to the dimension referred to as “L1” corresponding to the footprint of the solution known in the art. This significant reduction in the offset of the electric actuator 9 entails, on the one hand, a more compact valve, easy to integrate into the vehicle engine, and on the other hand a better resistance to vibration, since the centre of gravity of the engine is brought closer to that of the valve body which supports it.

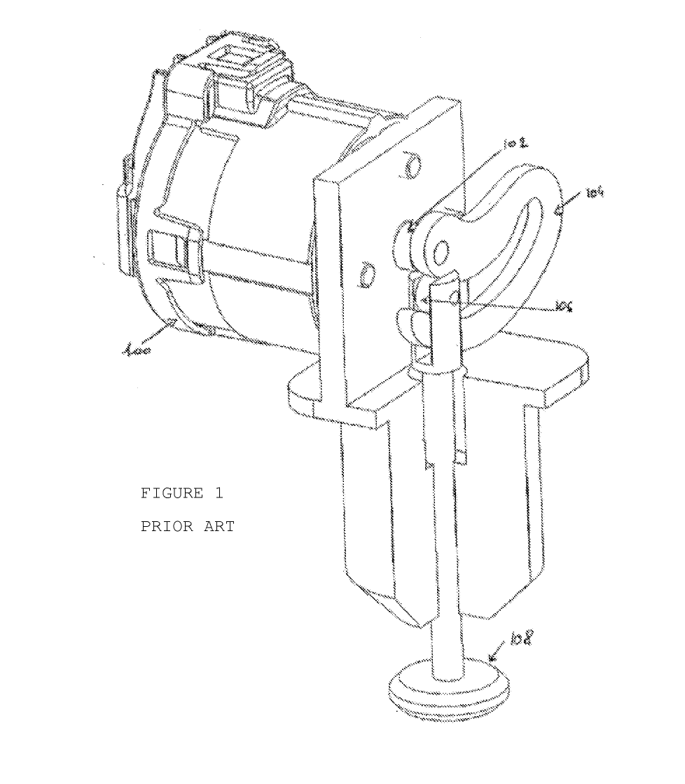

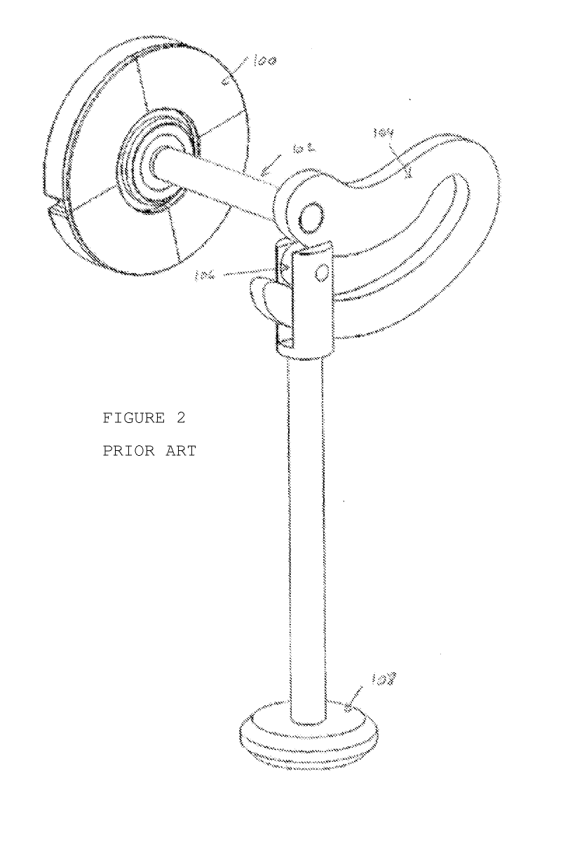

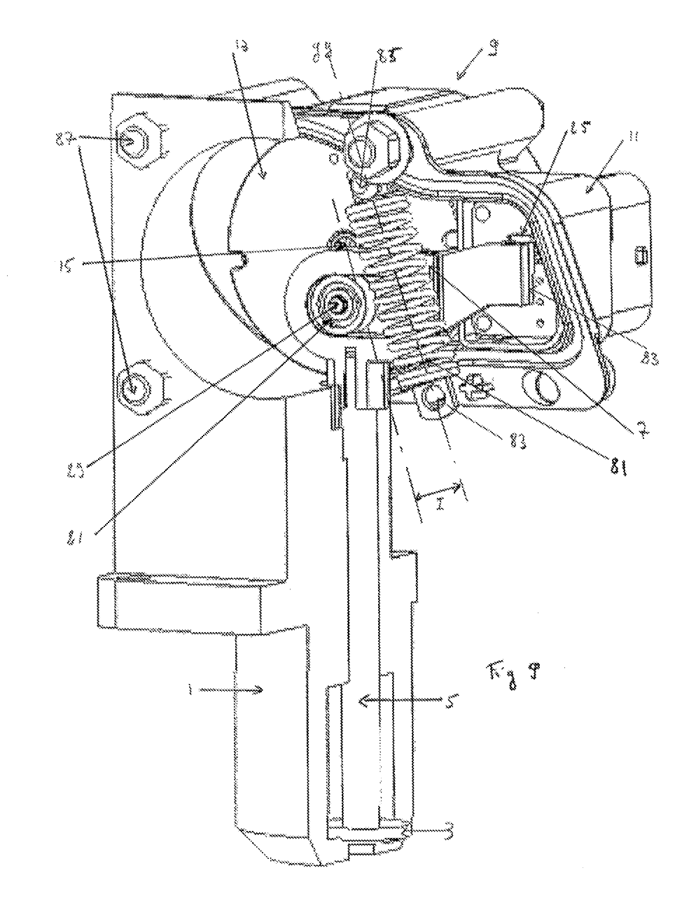

FIG. 9 is a perspective view of a second embodiment, which differs from the solution of FIGS. 1A and 1B by the addition of a return spring 81 in the referenced position, which is added to the torque produced at the magnetic support frame 17. The return spring is fixed between a stationary point 83 connected to the stator 11 or to the valve body 1 and a moving point 85 connected to the rotor assembly 13 or the cam element 7 at an eccentric point of the axis of rotation 15 of the rotor assembly 13, so that the line of action yy of said spring 81 is able to move with respect to the axis of rotation 15 of the magnetic support frame 17 during the movement of the valve shutter 3. The lever arm “1” of the spring 81 relative to the axis of rotation 15 of the lever 17 varies during the movement of the shutter valve 3 so that the restoring torque has a non-linear characteristic.

This non linear restoring torque ensures a function of return to the reference position (for example, with the valve closed), and has a reduced restoring torque in the other extreme position of the valve (for example in the open position), so as to help maintaining the second position with a low electric current. This advantage enables, on the one hand, to reduce the consumption of current generated by the battery, but also to protect the motor from overheating caused by the Joule effect inside the coils, added to the room temperature.

The thermal dissipation of the heat generated in the coils of the electrical actuator 9 can also be improved by using fastening elements 87 consisting of a good heat conducting material, for fixing the electric actuator 9 of the valve body 1 when the latter receives an external cooling. On the contrary, when the valve body has a high temperature and it is preferable to thermally insulate the electric actuator 9 of the valve body 1 whereon it rests, the electric actuator 9 will preferably be provided by non metallic lugs.

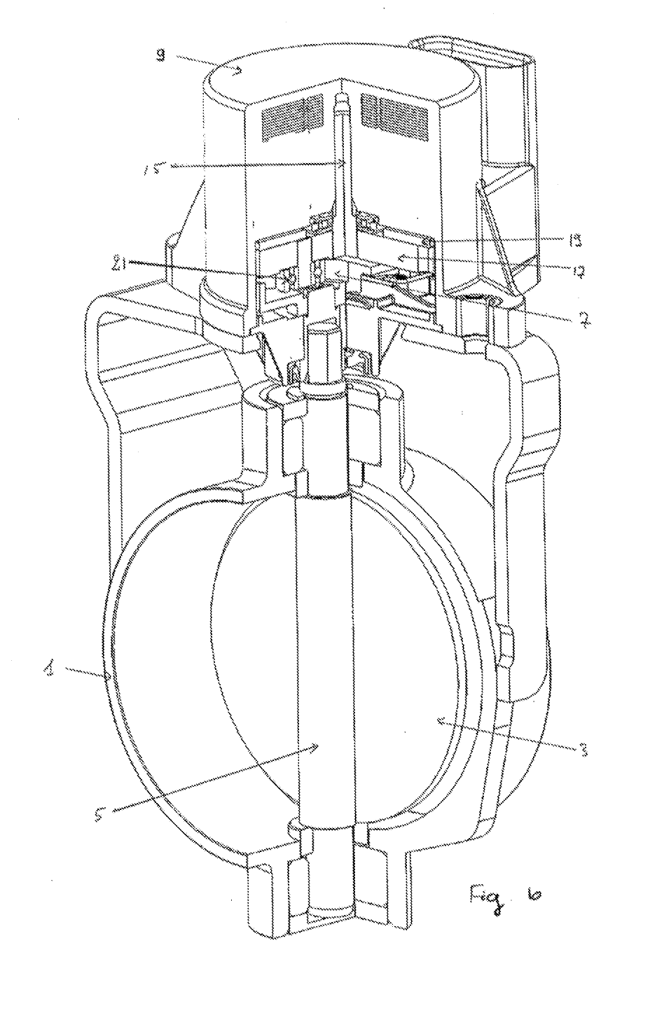

FIG. 10 is a perspective view of a third embodiment of the metering device, wherein the valve 3 is driven in a rotary movement in a tubular shaped valve body 1, in order to regulate the flow of gases. The electric actuator 9 includes a rotor 13 composed of a disk magnet 19 and a magnetic support frame 17, which transmits a rotary movement by means of the follower 21, to the cam element 7 able to move in rotation about the axis 5 bearing the valve shutter 3, so that the rotation of the valve shutter 3 enables to meter the fluid flowing within the valve body 1.

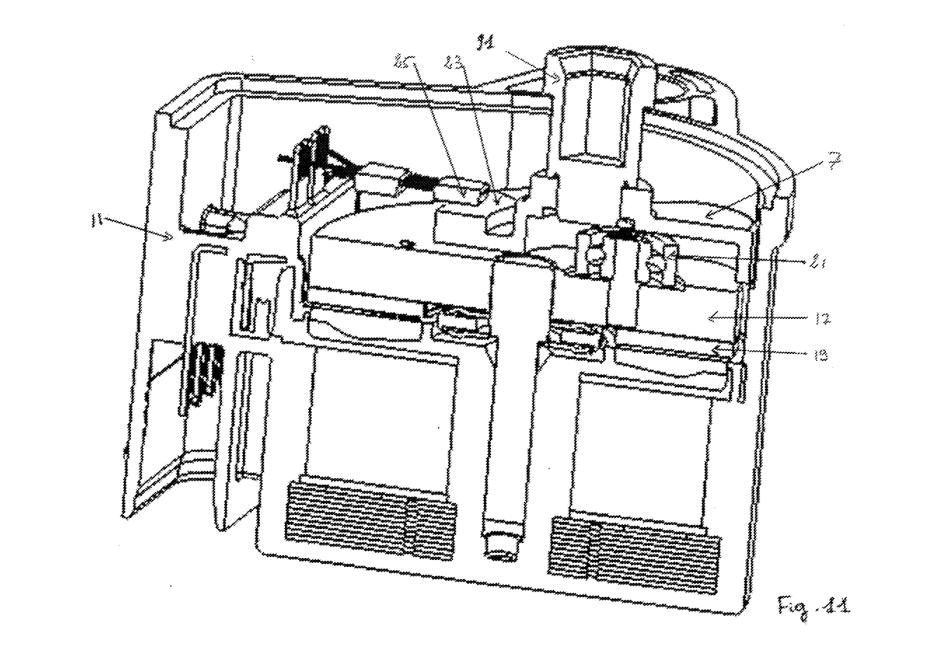

The rotary shutter metering valve is characterized by a highly integrated transmission kinematics, and makes it possible to improve the overall compactness of the valve by optimizing the height of the actuator/kinematics assembly. The cam element 7, the profile of the raceway of which may be curved, and is able to move in rotation fixed to the valve shaft 5 by means of a hub 91, in FIG. 11. The shape of the raceway of the cam element 7 is so selected as to amplify the rotation angle of the transmission shaft either by increasing the angular amplitude, or by increasing the torque according to the intended use.

The permanent magnet 23 fixed to the cam element 7 reacts with the magneto-sensitive element 25 which is secured to the stator 11. The rotary position sensor thus created enables to know the angular position of the valve shutter 3 and thereby to regulate the flow rate of the metering device.

The invention has been illustrated and described in detail in the drawings and foregoing description. The latter should be considered as illustrative and given as an example, and not as limiting the invention to such description. Many alternative embodiments are possible. For example, the return spring may also be used in a device equipped with a rotary valve shutter.

1. A metering device comprising:
a valve body equipped with a valve shutter adapted to move between a closed position and an open position;
a transmission shaft having a first end connected to the valve shutter and a second end connected to a cam element;
a rotary electric actuator comprising a stator assembly and a rotor assembly adapted to rotate about an axis of rotation, the rotor assembly comprising
a magnetic support frame (17) bearing a rotor magnet;
the rotor assembly further comprising a follower fixed directly on the magnetic support frame, and eccentric with respect to the axis of rotation and positioned with the ability to move in the cam element in order to convert the rotary movement of the rotor assembly into a movement of the transmission shaft.

2. The device according to claim 1, further comprising a permanent magnet fixed to the cam element, the permanent magnet cooperating with a magneto-sensitive element fixed to the stator assembly to act as a position sensor.

3. The device according to claim 2, wherein the cam element is made of a ferromagnetic material.

4. The device according to claim 2, wherein the position sensor operates in a linear mode.

5. The device according to claim 2, wherein the magneto-sensitive element is fixed to the stator assembly by a rigid conductive structure.

6. The device according to claim 1, further comprising a return spring having a first end fixed to the stator assembly and a second end fixed to the rotor assembly at an eccentric point of the axis of rotation of the rotor assembly.

7. The device according to claim 1, wherein the follower operably rotates about a nose fixed to the magnetic support frame, and the magnetic support frame, the axis of the rotor assembly and the nose are formed in a single metallic part.

8. The device according to claim 1, wherein the valve shutter and the transmission shaft move in a translational movement.

9. The device according to claim 8, characterized in that the cam element comprises a raceway intersecting the transmission shaft.

10. The device according to claim 9, wherein the raceway is perpendicular to the transmission shaft.

11. The device according to claim 1, wherein the valve shutter and the transmission shaft move in a rotation movement about a longitudinal axis of the transmission shaft.

12. The device according to claim 11, wherein the cam element comprises a raceway assisting modification of the angular stroke of the transmission shaft such that a stroke of the rotor assembly is fixed by the magnet and the stroke of only the follower/cam conversion can be changed.

13. A method for assembling a metering device, the method comprising:
fixing together a transmission shaft and a cam and then assembling the shaft and cam in a valve body;
fixing a follower to a magnetic support frame;
positioning the follower opposite the cam; and
pressing and fixing the electric actuator against the valve body.

14. The assembling method according to claim 13, further comprising magnetizing the rotor magnet after fixing thereof to the magnetic support frame.
